(19) United States
(12) Patent Application Publication
(10) Pub. No.: US 2014/0325168 A1
(43) Pub. Date: Oct. 30, 2014

(54) MANAGEMENT OF STORED DATA BASED ON CORRESPONDING ATTRIBUTE DATA

(71) Applicant: SAMSUNG ELECTRONICS CO., LTD., Suwon-Si (KR)

(72) Inventor: Eun Jin Yun, Seoul (KR)

(73) Assignee: SAMSUNG ELECTRONICS CO., LTD., Suwon-Si (KR)

(21) Appl. No.: 14/262,900

(22) Filed: Apr. 28, 2014

(30) Foreign Application Priority Data
Apr. 29, 2013 (KR) 10-2013-0047776

(51) Int. Cl. G06F 12/12

(52) U.S. Cl. CPC G06F 12/122
USPC 711/159

(57) ABSTRACT

A data storage device receives data and corresponding attribute data, stores the received data and the corresponding attribute data in a storage region of the data storage device, and automatically processes invalid data among the received data stored in the storage region based on the corresponding attribute data.

### CROSS-REFERENCE TO RELATED APPLICATIONS

This application claims priority under 35 U.S.C. §119 (a) to Korean Patent Application No. 10-2013-0047776 filed on Apr. 29, 2013, the subject matter of which is hereby incorporated by reference in its entirety.

### BACKGROUND OF THE INVENTION

Embodiments of the inventive concept relate generally to data storage technologies. More particularly, certain embodiments of the inventive concept relate to systems and methods that automatically process stored data based on corresponding attribute data.

High capacity data storage systems, such as solid state drives (SSDs), typically perform storage and access operations under control of a host. For example, they typically perform read, write, and erase operations in response to requests or commands received from a host. Consequently, the performance of those data storage systems is influenced, to some extent, by factors associated with the host-based control, such as the amount of time required for the host to issue requests and commands and the speed at which the host communicates those requests or commands.

In contexts where a data storage system is required to process a large number of memory requests, host-based control operations can pose a performance bottleneck. For example, in a flash-based data storage system where current data must be erased before new data can be written, significant time may be spent by the host to control erase operations.

In view of the foregoing, there is a general need for improved approaches to managing operations of high capacity data storage systems such as SSDs.

### SUMMARY OF THE INVENTION

In one embodiment of the inventive concept, a method of operating a data storage device comprises receiving data and corresponding attribute data, storing the received data and the corresponding attribute data in a storage region of the data storage device, and automatically processing invalid data among the received data stored in the storage region based on the corresponding attribute data.

In another embodiment of the inventive concept, a method of operating a data storage device comprises receiving data to be stored in a storage region of the data storage device, receiving attribute data corresponding to the received data, storing the received data and the received attribute data in the storage region, detecting invalid data among the stored data based on the stored attribute data, automatically processing the invalid data as a consequence of the detection.

In another embodiment of the inventive concept, a system comprises a data storage device comprising a storage region and configured to receiving data and corresponding attribute data, store the received data and the corresponding attribute data in the storage region, and automatically process invalid data among the received data stored in the storage region based on the corresponding attribute data.

These and other embodiments of the inventive concept, can potentially improve performance of a memory system by reducing data management overhead of a host and increasing the size of a programmable free storage region of the data storage device through automatic processing of invalid data.

### BRIEF DESCRIPTION OF THE DRAWINGS

The drawings illustrate selected embodiments of the inventive concept. In the drawings, like reference numbers indicate like features.

FIG. 1 is a block diagram of an electronic system according to an embodiment of the inventive concept.

FIG. 2 is a diagram illustrating a method of transmitting data and corresponding attribute data, according to an embodiment of the inventive concept.

FIG. 3 is a diagram illustrating a method of transmitting data and corresponding attribute data, according to another embodiment of the inventive concept.

FIG. 4 is a diagram illustrating a method of transmitting data and corresponding attribute data, according to still another embodiment of the inventive concept.

FIG. 5 is a conceptual diagram illustrating an operation for processing invalid data, by a memory controller illustrated in FIG. 1, among data stored in a storage region using attribute data, according to an embodiment of the inventive concept.

FIG. 6 is a flowchart illustrating a method of operating a data storage device, according to an embodiment of the inventive concept.

FIG. 7 is a flowchart illustrating a method of operating an electronic system, according to an embodiment of the inventive concept.

FIG. 8 is a flowchart illustrating a method of operating an electronic system, according to another embodiment of the inventive concept.

FIG. 9 is a block diagram of an electronic system, according to another embodiment of the inventive concept.

FIG. 10 is a block diagram of an electronic system, according to still another embodiment of the inventive concept.

FIG. 11 is a block diagram of an electronic system, according to still another embodiment of the inventive concept.

FIG. 12 is a block diagram of an electronic system, according to still another embodiment of the inventive concept.

FIG. 13 is a block diagram of an electronic system, according to still another embodiment of the inventive concept.

FIG. 14 is a block diagram of an electronic system, according to still another embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, where a feature is referred to as being “connected” or “coupled” to another feature, it can be directly connected or coupled to the other feature or intervening features may be present. In contrast, when a feature is referred to as being “directly connected” or “directly coupled” to another feature, there are no intervening features present. As used herein, the term “and/or” includes any and all combinations of one or more of the associated listed items and may be abbreviated as “/”.

Although the terms first, second, etc. may be used herein to describe various features, the described features should not be limited by these terms. Rather, these terms are used merely to distinguish one feature from another. For example, a first signal could be termed a second signal, and vice versa, without departing from the teachings of the disclosure.

The terminology used herein is for the purpose of describing particular embodiments only and is not intended to limit the inventive concept. As used herein, the singular forms “a”, “an” and “the” are intended to include the plural forms as well, unless the context clearly indicates otherwise. Terms such as “comprises” and/or “comprising,” or “includes” and/or “including” where used in this specification, indicate the presence of stated features but do not preclude the presence of other features.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present application and should not be interpreted in an idealized or overly formal sense unless expressly so defined herein.

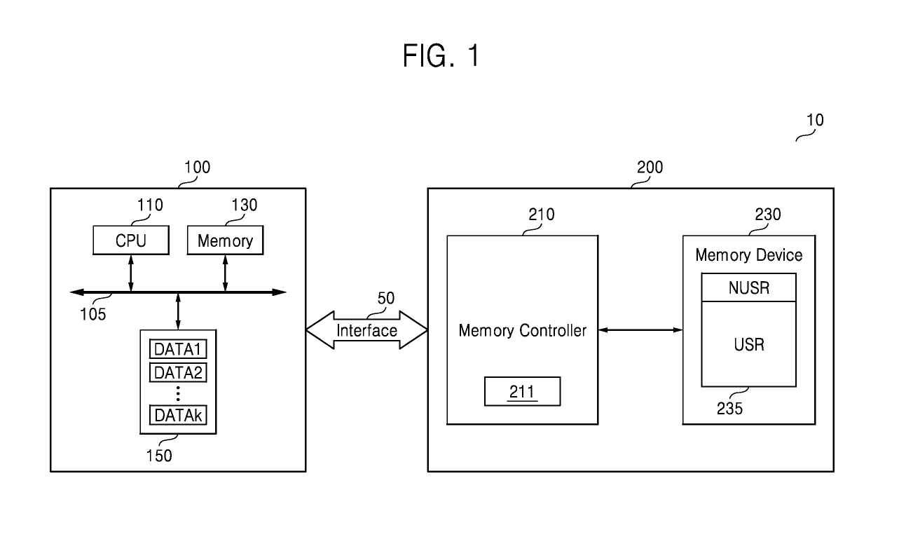

FIG. 1 is a block diagram of an electronic system according to an embodiment of the inventive concept.

Referring to FIG. 1, an electronic system 10 comprises a host 100 and a data storage device (or storage) 200. Host 100 comprises a central processing unit (CPU) 110, a first memory 130, and a second memory 150. Data storage device 200 comprises a memory controller 210 storing a logical to physical mapping table 211, and a memory device 230 comprising a storage region 235 divided into a user storage region (USR) and a non-user storage region (NUSR).

Electronic system 10 automatically processes invalid data among data DATA1 to DATAk stored in data storage device 200 by using attribute data for an attribute of data DATA1 to DATAk. Electronic system 10 may take various alternative forms, such as a personal computer (PC), a data server, a database server, a cache server, a web server, a network-attached storage (NAS), or a portable electronic device, to name but a few examples. The portable electronic device may be, for instance, a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, or an e-book.

Host 100 communicates with data storage device 200 through an interface 50, which implements an interface protocol for the communication. The interface protocol may be, for instance, a protocol conforming to a standard such as UHI (UHS-I or UHS-II), peripheral component interconnect-express (PCI-E), advanced attached SCSI (ATA), serial advanced technology attachment (SATA), serial attached SCSI (SAS), double data rate x (DDRx), Universal Serial Bus (USB), multi-media card (MMC), embedded MMC(eMMC), enhanced small disk interface (ESDI), Integrated Drive Electronics (IDE).

Host 100 generates attribute data for data DATA1 to DATAk. The attribute data may include, for instance, information on a validity period of data DATA1 to DATAk, an access frequency, a size of data, or a function regarding the validity period. In addition, the each attribute data may include a data life cycle of data DATA1 to DATAk, information or a function of data durability, information on a data tier, or information on data age.

Host 100 transmits data DATA1 to DATAk and corresponding attribute data to data storage device 200. In some embodiments, host 100 also generates an adjustment command for changing or updating the attribute data, and transmits the generated adjustment command to data storage device 200. Host 100 may be, for example, an application processor or a mobile application processor, although it is not limited thereto.

CPU 110, first memory 130, and second memory 150 communicate with each other through a bus 105. CPU 110 controls operation of host 100, and can be substituted by another type of control circuit that performs a similar function. For example, CPU 110 could be replaced with a processor or a multi-core processor.

CPU 110 executes a program that generates attribute data for each of data DATA1 to DATAk. Such a program may be, for instance, an operating system (OS), an application program, or a set of functions defined by an application programming interface (API).

First memory 130 may be an operation memory where a program for generating each attribute data for an attribute of data DATA1 to DATAk is stored, or it may be embodied in a volatile memory device or a non-volatile memory device. The volatile memory device may be, for instance, a dynamic random access memory (DRAM), a static random access memory (SRAM), a thyristor RAM (T-RAM), a zero capacitor RAM (Z-RAM), or a Twin Transistor RAM (TTRAM). The non-volatile memory device may be, for instance, an Electronically Erasable Programmable Read-Only Memory (EEPROM), a flash memory, a Magnetic RAM (MRAM), a Spin-Transfer Torque (STT)-MRAM, a Conductive bridging RAM (CBRAM), a Ferroelectric RAM (FeRAM), a Phase change RAM (PRAM), a Resistive RAM (RRAM), a Nanotube RRAM, a Polymer RAM (PoRAM), a Nano Floating Gate Memory (NFGM), a holographic memory, a Molecular Electronics Memory Device, or an Insulator Resistance Change Memory. The non-volatile memory device may also be, for instance, a hard disk drive (HDD) or a solid state drive (SSD). Second memory 150 stores data DATA1 to DATAk. Second memory 150 may be, for instance, one of the above-mentioned volatile memory devices or non-volatile memory devices.

For convenience of description, FIG. 1 illustrate data DATA1 to DATAk stored in second memory 150 separate from first memory 130. However, data DATA1 to DATAk may be stored in first memory 130 in other embodiments. According to still other embodiments, second memory 150 where data DATA1 to DATAk is stored may be a data server or a database embodied not inside host 100 but outside.

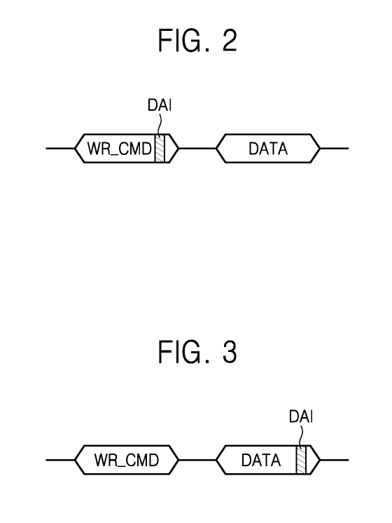

FIGS. 2 to 4 are diagrams illustrating various methods of transmitting data and corresponding attribute data, according to embodiments of the inventive concept. As illustrated in FIGS. 2 to 4, host 100 transmits data DATA and corresponding attribute data DAI to data storage device 200.

Referring to FIGS. 1 and 2, host 100 generates a write command WR_CMD comprising attribute data DAI, and transmits write command WR_CMD to data storage device 200. Host 100 transmits data DATA1 to DATAk, collectively DATA, to data storage device 200.

Referring to FIGS. 1 and 3, host 100 generates a write command WR_CMD for writing data DATA in data storage device 200, and transmits write command WR_CMD to data storage device 200. In addition, host 100 transmits data DATA comprising attribute data DAI to data storage device 200. For example, attribute data DAI may be included in metadata of data DATA.

In FIG. 3, attribute data DAI is illustrated to be included in data DATA, but different units of attribute data DAI may be included in different units of data DATA1 to DATAk.

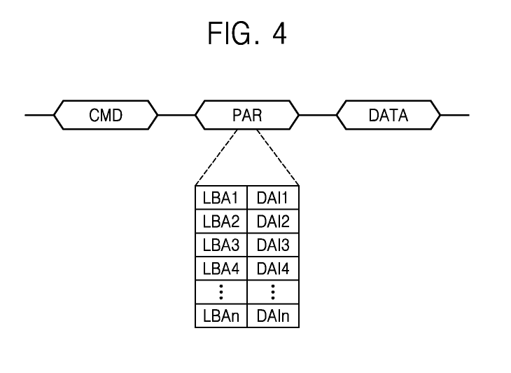

Referring to FIGS. 1 and 4, host 100 generates a command CMD newly defined so as to transmit attribute data DAI to data storage device 200, and transmits the generated command CMD to data storage device 200. For example, the newly defined command CMD may be a vendor specific command.

Host 100 transmits a parameter PAR comprising attribute data DAI to data storage device 200. As illustrated in FIG. 4, parameter PAR comprises logical block addresses LBA1 to LBAn and corresponding attribute data DAI1 to DAIn. For example, each logical block address LBA1 to LBAn may indicate a range of addresses or a single logical block address, and attribute data DAI may include attributes data DAI1 to DAIn. Host 100 typically transmits attribute data DAI included in parameter PAR to data storage device 200 before transmitting data DATA to data storage device 200.

Referring to FIGS. 1 to 4, data storage device 200 receives data DATA1 to DATAk transmitted from host 100 and corresponding attribute data DAI. Data storage device 200 stores data DATA1 to DATAk and attribute data DAI in a storage region 235. Based on attribute data DAI, data storage device 200 may automatically process invalid data among data DATA1 to DATAk written in storage region 235. That is, data storage device 200 may automatically process invalid data among data DATA1 to DATAk written in storage region 235 by corresponding to attribute data DAI. The invalid data may be, for example, data that is not often accessed by host 100.

Accordingly, data storage device 200 may automatically process invalid data among data DATA1 to DATAk written in data storage device 200 using attribute data DAI. As a result, host 100 may reduce overhead for managing data DATA1 to DATAk stored in data storage device 200, so that a management efficiency and performance of electronic system 10 may be improved.

Moreover, data storage device 200 may automatically process invalid data based on attribute data DAI to produce a free storage region or space where data storage device 200 may be programmed. Accordingly, data storage device 200 is improved in performance and reliability of data storage device 200 may be ensured.

Data storage device 200 may comprise, for instance, an SSD, a universal flash storage (UFS), a flash universal serial bus (USB) drive, a secure digital (SD) card, a multimedia card (MMC), an embedded MMC (eMMC), a smart card, a memory card, or a redundant array of independent disks or redundant array of inexpensive disks (RAID). Data storage device 200 may also comprise, for instance, a flash-based data storage device comprising a flash memory controller such as an eMMC, a UFS, or a SSD.

Memory controller 210 controls communication between host 100 and data storage device 200. Memory controller 210 controls operation of writing data DATA1 to DATAk transmitted from host 100 in storage region 235 corresponding to memory device 230.

Memory device 230 may take the form of a volatile or nonvolatile memory device, such as those mentioned above. Within memory device 230, user storage region USR typically comprises a used storage region where specific data is already stored and a programmable free storage region. Non-user storage region NUSR typically stores metadata for managing data storage device 200, and information or data on an attribute of data storage device 200 or an internal operation necessary for an efficient management of data storage device 200 (e.g., performance adjustment, merge, wear leveling, garbage collection). In non-user storage region NUSR, a signal, e.g., a command or data, transmitted from host 100 or a signal, e.g., a command or data, input to host 100 may be temporarily stored.

Where an error or a defect occurs in blocks included in user storage region USR, non-user storage region NUSR may include a redundancy region replacing blocks where the error or defect occurs. Data DATA1 to DATAk may be written in user storage region USR of storage region 235 under control of memory controller 210.

Memory controller 210 manages attribute data DAI transmitted from host 100. In some embodiments, memory controller 210 stores both data DATA1 to DATAk and corresponding attribute data DAI in user storage region USR of storage region 235. Here, the corresponding attribute data DAI may be stored in a region where metadata of data DATA1 to DATAk is stored. In some other embodiments, memory controller 210 stores attribute data DAI of data DATA1 to DATAk in non-user storage region NUSR of storage region 235.

In some embodiments, memory controller 210 stores both data DATA1 to DATAk, corresponding attribute data DAI, and a logical block address of data DATA1 to DATAk in a logical to physical mapping table 211.

In some embodiments, memory controller 210 monitors attribute data DAI of data DATA1 to DATAk, and transmit information on a state of data DATA1 to DATAk to host 100 according to a result of the monitoring. For example, the information on a state may include an access frequency of data DATA1 to DATAk or a remaining validity period.

Here, host 100, according to the information on a state of data DATA1 to DATAk transmitted from data storage device 200, may generate an adjustment command for changing attribute data DAI, and transmit the generated adjustment command to data storage device 200. The adjustment command may be used, for example, to program or modify a validity period of data DATA 1 to DATAk.

In some embodiments, memory controller 210 compresses data whose attributes are identical among data DATA1 to DATAk stored in user storage region USR, or data that matches a block region of user storage region USR based on attribute data DAI of data DATA1 to DATAk.

In some embodiments, memory controller 210 changes or updates attribute data DAI of data DATA1 to DATAk in response to an adjustment command transmitted from host 100. For example, an attribute of data DATA1 to DATAk stored in data storage device 200 may be changed under control of memory controller 210. In some embodiments, memory controller 210 changes attribute data DAI of data DATA1 to DATAk based on a state change such as an access frequency of data DATA1 to DATAk stored in user storage region USR of storage region 235.

Based on attribute data DAI, memory controller 210 may automatically process invalid data among data DATA1 to DATAk written in user storage region USR of storage region 235 without an additional command from host 100. For example, memory controller 210 may automatically erase invalid data among data DATA1 to DATAk in user storage region USR of storage region 235 without an additional erase command from host 100. Moreover, memory controller 210 may automatically erase the invalid data during performance of a garbage collection operation.

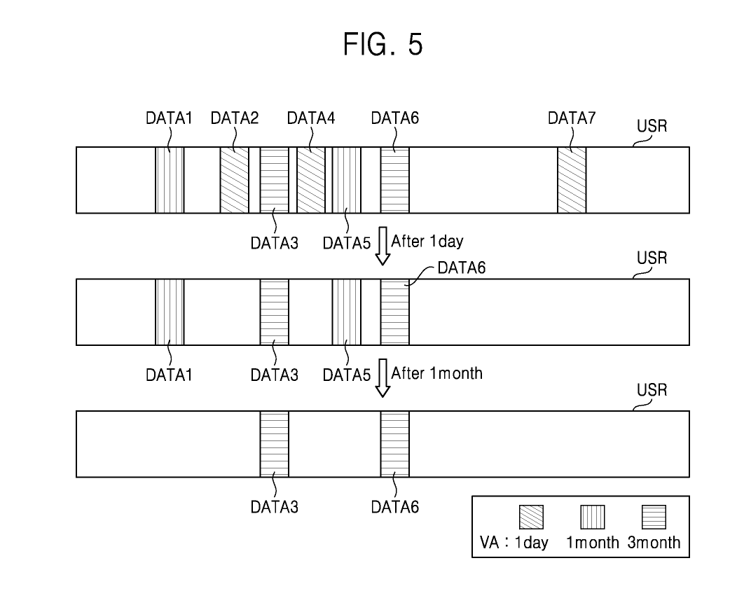

FIG. 5 is a conceptual diagram illustrating an operation of processing invalid data in storage region 235 using attribute data, according to an embodiment of the inventive concept. In the described example, the operation is performed by memory controller 210 of FIG. 1. For convenience explanation, seven units of data DATA1 to DATA7 are illustrated, and where attribute data DAI includes information on a validity period, only one operation is assumed which data storage device 200 automatically erases data.

Referring to FIGS. 1 to 5, a validity period VA of each data DATA2, DATA4, and DATA7 is one day. A validity period VA of data DATA1 and DATA5 is one-month. A validity period VA of each data DATA3 and DATA6 is three-months. After the validity period VA of one-day elapses, each data DATA2, DATA4, and DATA7 is automatically erased as invalid data under the control of memory controller 210. After the validity period VA of one month elapses, data DATA1 and DATA5 is automatically erased as invalid data under the control of memory controller 210. Until the validity period VA of three months elapses, each data DATA3 and DATA6 is not automatically erased under the control of memory controller 210.

Here, data storage device 200 increases the amount of space in the programmable free storage region by automatically erasing each invalid data DATA2, DATA3, DATA4, DATA6, and DATA7 without an additional erase command from host 100.

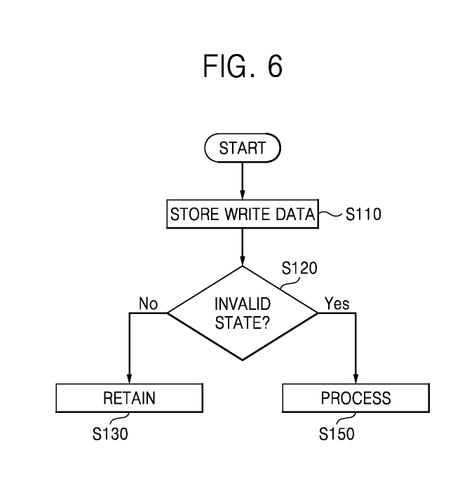

FIG. 6 is a flowchart illustrating a method of operating a data storage device according to an embodiment of the inventive concept. For explanation purposes, this and other methods will be described with reference to electronic system 10 of FIG. 1, but the described methods are not limited to this system implementation.

Referring to FIGS. 1 to 6, data DATA1 to DATAk is stored in storage region 235 (S110). Thereafter, data storage device 200 monitors attribute data DAI of data DATA1 to DATAk and determines a state of data DATA1 to DATAk stored in storage region 235 according to a result of the monitoring (S120).

Where the state is valid (S120=No), data storage device 200 retains data DATA1 to DATAk stored in storage region 235 (S130). For example, as described in FIG. 5, where the validity period VA has not elapsed, data storage device 200 may retain data DATA1 to DATAk stored in storage region 235. In other words, data storage device 200 does not erase data DATA1 to DATAk. Here, data storage device 200 transmits information on the state of data DATA1 to DATAk to host 100 based on a result of the monitoring.

Where the state is invalid (S120=Yes), data storage device 200 automatically processes invalid data among data DATA1 to DATAk stored in storage region 235 (S150). For example, as described in FIG. 5, when the validity period VA has elapsed, data storage device 200 may automatically erase invalid data whose validity period VA has elapsed among data DATA1 to DATAk stored in storage region 235 (S150).

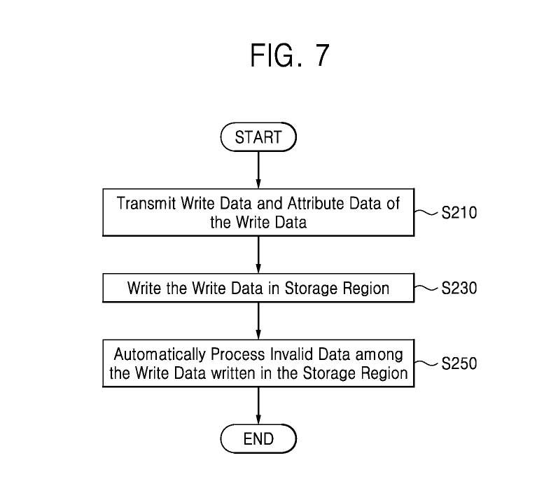

FIG. 7 is a flowchart illustrating a method of operating electronic system 10, according to an embodiment of the inventive concept.

Referring to FIGS. 1 to 7, host 100 transmits data DATA1 to DATAk and attribute data DAI indicating the attribute of data DATA1 to DATAk to data storage device 200 (S210).

In some embodiments, attribute data DAI of data DATA1 to DATAk is included in a write command WR_CMD generated by host 100. In some other embodiments, attribute data DAI of data DATA1 to DATAk is included in metadata of data DATA1 to DATAk.

Next, data storage device 200 writes data DATA1 to DATAk in storage region 235 (S230). Based on attribute data DAI, data storage device 200 automatically processes (e.g., erases) invalid data among data DATA1 to DATAk written in storage region 235 (S250).

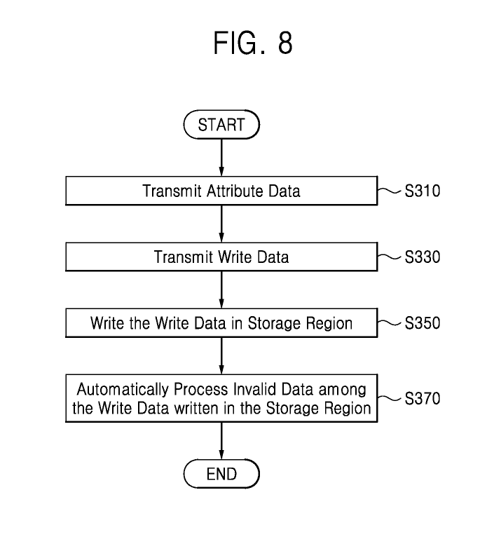

FIG. 8 is a flowchart illustrating a method of operating electronic system 10, according to another embodiment of the inventive concept.

Referring to FIGS. 1 to 6, and 8, host 100 transmits attribute data DAI of data DATA1 to DATAk to data storage device 200 (S310). In some embodiments, attribute data DAI of data DATA1 to DATAk is included in parameter PAR. Here, host 100 transmits a newly-defined command CMD to data storage device 200 so as to transmit attribute data DAI to data storage device 200 and transmit parameter PAR including attribute data DAI to data storage device 200.

Next, host 100 transmits data DATA1 to DATAk to data storage device 200 (S330). Data storage device 200 writes data DATA1 to DATAk in storage region 235 (S350). Based on attribute data DAI, data storage device 200 automatically processes (e.g., erases) invalid data among data DATA1 to DATAk written in storage region 235 (S370).

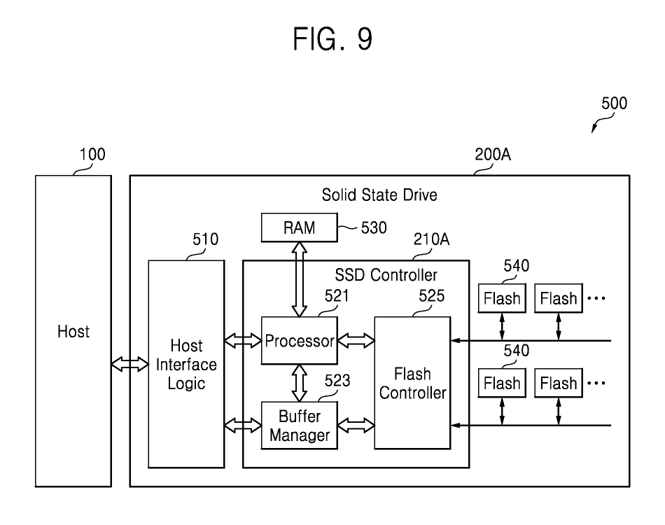

FIG. 9 is a block diagram of an electronic system, according to another embodiment of the inventive concept.

Referring to FIG. 9, an electronic system 500 comprises host 100 and an SSD 200A. SSD 200A comprises host interface logic 510, an SSD controller 210A, a storage device 530, and flash memory devices 540. A storage region like storage region 235 may be included in each of flash memory devices 540. Storage device 530 may take the form of a volatile or nonvolatile memory device, such as one of those mentioned above.

Host interface logic 510 facilitates communication between host 100 and SSD controller 210A. SSD controller 210A controls storage and access of data transmitted and received among host interface logic 510, storage device 530, and flash memory devices 540. SSD controller 210A comprises a processor 521, a buffer manager 523, and a flash controller 525.

Processor 521 controls operation of SSD controller 210A. For example, processor 521 controls operations of buffer manager 523 and flash controller 525.

Buffer manager 523 controls buffering of data communicated between host interface logic 510 and flash controller 525. Flash controller 525 controls data communicated between flash memory devices 540 and buffer manager 523.

Under the control of SSD controller 210A, data DATA1 to DATAk transmitted from host 100 may be written in flash memory devices 540, and attribute data DAI for the attribute of data DATA1 to DATAk transmitted from host 100 may be managed. In addition, under control of SSD controller 210A based on attribute data DAI, invalid data among data DATA1 to DATAk written in flash memory devices 540 may be automatically processed.

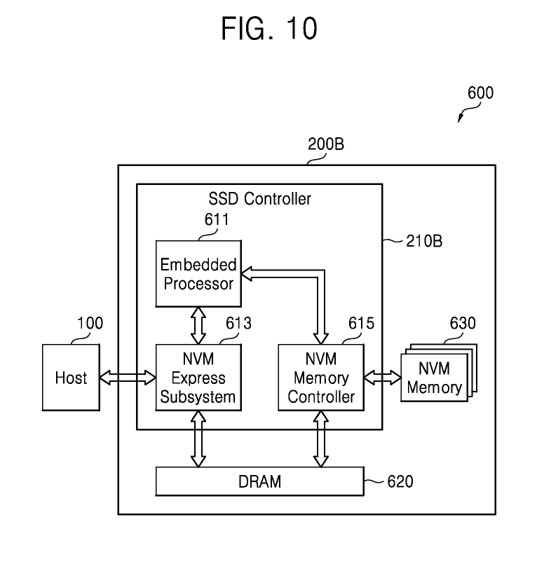

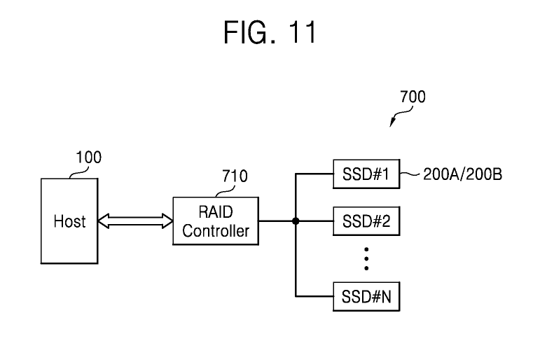

FIG. 10 is a block diagram of an electronic system according to still another embodiment of the inventive concept.

Referring to FIG. 10, an electronic system 600 comprises host 100 and data storage device 200B. Data storage device 200B comprises an SSD controller 210B which may support non-volatile memory (NVM) Express (NVMe), a storage device 620, and non-volatile memories 630.

SSD controller 210B comprises an embedded processor 611, an NVM express sub system 613, and an NVM memory controller 615. Embedded processor 611 controls operation of NVM express sub system 613 and NVM memory controller 615.

NVM express sub system 613 receives and processes data DATA1 to DATAk and attribute data DAI for an attribute of data DATA1 to DATAk transmitted from host 100. Each of NVM express sub system 613 and NVM memory controller 615 may access storage device 620. Storage device 620 may be embodied in a volatile memory such as a dynamic random access memory (DRAM).

Storage region 235 may be embodied in each of non-volatile memories 630. Under control of SSD controller 210B, e.g., NVM memory controller 615, data DATA1 to DATAk transmitted from host 100 may be written in non-volatile memories 630, and attribute data DAI for the attribute of data DATA1 to DATAk transmitted from host 100 may be managed. Moreover, according to a control of NVM memory controller 615 based on attribute data DAI, invalid data among data DATA1 to DATAk written in non-volatile memories 630 may be automatically processed.

FIG. 11 is a block diagram of an electronic system according to still another embodiment of the inventive concept.

Referring to FIG. 11, a system 700 comprises host 100, a redundant array of independent disks (RAID) controller 710, and a plurality of SSDs 200A or 200B.

Storage region 235 may be included in at least one of the plurality of SSDs 200A or 200B. Under control of RAID controller 710 and/or SSD controller 210A or 210B, data DATA1 to DATAk transmitted from host 100 may be written in at least one of the plurality of SSDs 200A or 200B.

Attribute data DAI for the attribute of data DATA1 to DATAk transmitted from host 100 may be managed based on the control of RAID controller 710 and/or SSD controller 210A or 210B. Under control of RAID controller 710 and/or SSD controller 210A or 210B, after a validity period VA elapses, invalid data among the data written in at least one of the plurality of SSDs 200A or 200B may be automatically processed or erased.

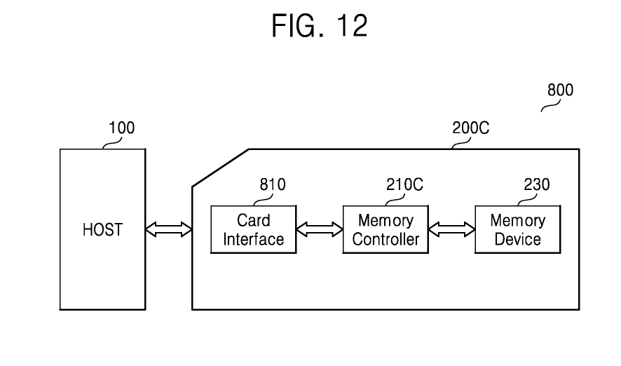

FIG. 12 is a block diagram of an electronic system according to still another embodiment of the inventive concept. Referring to FIG. 12, an electronic system 800 may include host 100 and a memory card 200C. Memory card 200C may be a smart card, an MMC, or an eMMC.

Memory card 200C comprises a card interface 810 communicating with host 100, a non-volatile memory device 400, and a memory controller 210C controlling data communication between card interface 810 and non-volatile memory device 400.

In some embodiments, card interface 810 may be a secure digital (SD) card interface or a multi-media card (MMC) interface; however, it is not limited thereto.

Card interface 810 facilitates data exchange between host 100 and memory controller 210C according to a protocol of host 100. In some embodiments, card interface 810 may support a USB protocol, or an IC-USB protocol. Here, the card interface may denote hardware which may support a protocol used by host 100, software installed in the hardware, or a signal transmission mode.

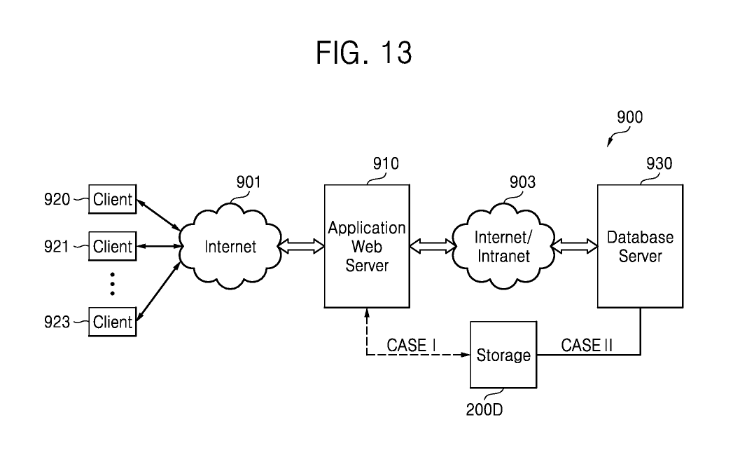

FIG. 13 is a block diagram of an electronic system according to still another embodiment of the inventive concept.

Referring to FIG. 13, an electronic system 900 comprises an application web server 910, a plurality of clients 920 to 923, and a data storage device 200D.

Application web server 910 and clients 920 to 923 form a communication network through an internet 901. Application web server 910 performs a function of host 100, and data storage device 200D performs a function of data storage device 200.

According to a case I (CASE I), application web server 910 transmits data DATA1 to DATAk and attribute data DAI of data DATA1 to DATAk to data storage device 200D, and data storage device 200D writes data DATA1 to DATAk in the storage region of data storage device 200D, and automatically process invalid data among data DATA1 to DATAk written in the storage region based on attribute data DAI.

According to a case II (CASE II), the electronic system 900 further comprises a database server 930. In this case, application web server 910 and the database server 930 are connected through an internet or intranet 903. In this case, the database server 930 may perform a function of host 100, and data storage device 200D may perform a function of data storage device 200. Accordingly, the database server 930 transmits data DATA1 to DATAk and attribute data DAI for the attribute of data DATA1 to DATAk to data storage device 200D, and data storage device 200D writes data DATA1 to DATAk in the storage region of data storage device 200D, and automatically processes invalid data among data DATA1 to DATAk written in the storage region based on attribute data DAI.

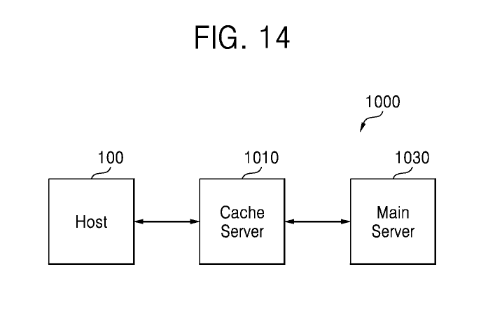

FIG. 14 is a block diagram of an electronic system according to still another embodiment of the inventive concept.

Referring to FIG. 14, an electronic system 1000 comprises host 100, a cache server 1010, and a main server 1030. Cache server 1010 performs a function of data storage device 200. Main server 1030 stores host usable data which include data DATA1 to DATAk. For example, main server 1030 may be a web server supplying data to host 100.

Host 100 reads data DATA1 to DATAk from main server 1030 and stores data DATA1 to DATAk which are often used in the cache server so as to quickly read the data without going through main server 1030.

Cache server 1010 copies and stores data that is accessed with relatively high frequency by host 100 among the data stored in main server 1030, and supplies the copied data to host 100 according to a request of host 100. Here, host 100 transmits data DATA1 to DATAk and attribute data DAI for the attribute of data DATA1 to DATAk to cache server 1010.

Cache server 1010 stores data DATA1 to DATAk and automatically erases invalid data among data DATA1 to DATAk based on attribute data DAI. That is, cache server 1010 may automatically process, e.g., erase, data which are not often accessed by host 100 as the invalid data.

Host 100 does not read the processed invalid data, e.g., the erased invalid data, among data DATA1 to DATAk from cache server 1010. However, it may write or copy again the processed invalid data from main server 1030 where data DATA1 to DATAk is stored to cache server 1010. As described above, data DATA1 to DATAk may be treated as a piece of data or additional data. Accordingly, the attribute data may be generated as one or an additional one.

As indicated by the foregoing, in certain embodiments of the inventive concept, a data storage device automatically processes invalid data without a command or request from a host. This automatic processing can reduce data management overhead of the host, and it can also increase the size of a programmable free storage region of the data storage device by automatically erasing invalid data.

The foregoing is illustrative of embodiments and is not to be construed as limiting thereof. Although a few embodiments have been described, those skilled in the art will readily appreciate that many modifications are possible in the embodiments without materially departing from the scope of the inventive concept. Accordingly, all such modifications are intended to be included within the scope of the inventive concept as defined in the claims.

What is claimed is:

1. A method of operating a data storage device, comprising:
receiving data and corresponding attribute data;
storing the received data and the corresponding attribute data in a storage region of the data storage device; and
automatically processing invalid data among the received data stored in the storage region based on the corresponding attribute data.

2. The method of claim 1, wherein automatically processing the invalid data comprises inspecting the corresponding attribute data, and initiating an erase operation of the invalid data based on the inspection.

3. The method of claim 1, wherein automatically processing the invalid data comprises erasing the invalid data without receiving an erase command from a host.

4. The method of claim 1, wherein the attribute data is included in a write command transmitted from a host to the data storage device.

5. The method of claim 1, wherein the attribute data is included in metadata associated with the received data.

6. The method of claim 1, further comprising changing the attribute data in response to an adjustment command transmitted to the data storage device from a host.

7. The method of claim 6, wherein changing the attribute data comprises adjusting a validity period associated with the received data.

8. The method of claim 1, further comprising changing the attribute data based on a state change of the received data.

9. The method of claim 8, wherein the state change corresponds to an increased access frequency of the received data.

10. The method of claim 1, further comprising monitoring the attribute data and transmitting information on a state of the data to a host based on a result of the monitoring.

11. The method of claim 1, wherein the attribute data comprises information regarding a validity period of the data, an access frequency of the data, a size of the data, a function related to a validity period, a data life cycle of the data, data durability, a function related to data durability, a data tier, or data age.

12. A method of operating a data storage device, comprising:
receiving data to be stored in a storage region of the data storage device;
receiving attribute data corresponding to the received data;
storing the received data and the received attribute data in the storage region;
detecting invalid data among the stored data based on the stored attribute data; and
automatically processing the invalid data as a consequence of the detection.

13. The method of claim 12, further comprising changing the stored attribute data in response to an adjustment command transmitted from a host.

14. The method of claim 12, further comprising changing the stored attribute data based on a state change of the data.

15. The method of claim 12, further comprising monitoring the attribute data and transmitting information on a state of the data to a host based on a result of the monitoring.

16. A system, comprising:
a data storage device comprising a storage region and configured to receiving data and corresponding attribute data, store the received data and the corresponding attribute data in the storage region, and automatically process invalid data among the received data stored in the storage region based on the corresponding attribute data.

17. The system of claim 16, further comprising:
a host configured to generate the attribute data and to transmit the attribute data and the data to the data storage device; and

18. The system of claim 16, wherein the attribute data is included in a write command.

19. The system of claim 16, wherein the attribute data is included in metadata of the data.

20. The system of claim 16, further comprising transmitting an adjustment command for changing the attribute data to the data storage device according to information on a state of the data transmitted from the data storage device.
